(19) United States
(12) Patent Application Publication
(10) Pub. No.: US 2015/0153784 A1
(43) Pub. Date: Jun. 4, 2015

(54) ELECTRONIC APPARATUS

(71) Applicant: KABUSHIKI KAISHA TOSHIBA, Tokyo (JP)

(72) Inventor: Johnsan Wu, Taipei (TW)

(21) Appl. No.: 14/616,437

(22) Filed: Feb. 6, 2015

Related U.S. Application Data
(63) Continuation of application No. PCT/JP2013/073725, filed on Aug. 28, 2013.

(30) Foreign Application Priority Data
Oct. 25, 2012 (JP) 2012-235899

(51) Int. Cl. G06F 1/16

(52) U.S. Cl. CPC G06F 1/1658

(57) ABSTRACT

According to one embodiment, an electronic apparatus includes a housing with at least one opening, a connector in the housing, a unit in the housing and connected to the connector by one end and a flexible support integrated with the housing and projecting in the opening, configured to support an other end of the unit.

### CROSS REFERENCE TO RELATED APPLICATIONS

This application is a Continuation Application of PCT Application No. PCT/JP2013/073725, filed Aug. 28, 2013 and based upon and claiming the benefit of priority from Japanese Patent Application No. 2012-235899, filed Oct. 25, 2012, the entire contents of all of which are incorporated herein by reference.

### FIELD

Embodiments described herein relate generally to an electronic apparatus comprising a part.

### BACKGROUND

For example, notebook type personal computers are widely used. For such notebook type personal computers, there are tendencies that lighter ones in weight or thinner ones in size are preferred in consideration of user-friendliness.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view of a portable computer, which is an example of an electronic apparatus of a first embodiment;

FIG. 2 is an exemplary plan view showing an inside of a mount area of a main body cabinet of the electronic apparatus shown in FIG. 1, a PCI Express card of a full size, a PCI Express card of a half size and an SSD (solid state drive) card;

FIG. 3 is an exemplary plan view showing the mount area of the main body cabinet of the electronic apparatus shown in FIG. 1 as viewed from an inner side of the mount area;

FIG. 4 is an exemplary perspective view showing the mount area of the main body cabinet of the electronic apparatus, the PCI Express card of a full size, the PCI Express card of a half size and the SSD (solid state drive) card, shown in FIG. 1 as viewed from an inner side of the mount area;

FIG. 5 is an exemplary cross section taken along the line F5-F5 of the electronic apparatus shown in FIG. 2;

FIG. 6 is an exemplary plan view of a support of a portable computer, which is an example of an electronic apparatus of a second embodiment;

FIG. 7 is an exemplary plan view of a support of an electronic apparatus, which is a modified example of the second embodiment;

FIG. 8 is an exemplary plan view of a support of a portable computer, which is an example of an electronic apparatus of a third embodiment; and

FIG. 9 is an exemplary plan view of a support of a portable computer, which is an example of an electronic apparatus of a fourth embodiment.

### DETAILED DESCRIPTION

Various embodiments will be described hereinafter with reference to the accompanying drawings.

An object to achieve by the embodiments is to provide an electronic apparatus with improved user-friendliness.

In general, an electronic apparatus according to one embodiment comprises a housing with at least one opening, a connector in the housing, a unit in the housing and connected to the connector by one end and a flexible support integrated with the housing, and projecting in the opening, configured to support an other end of the unit.

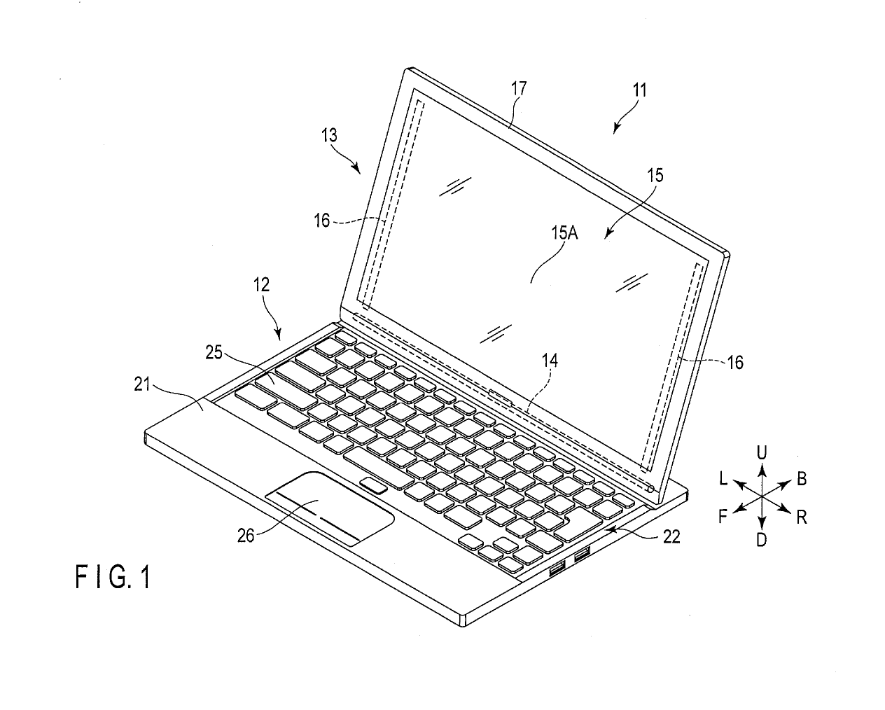

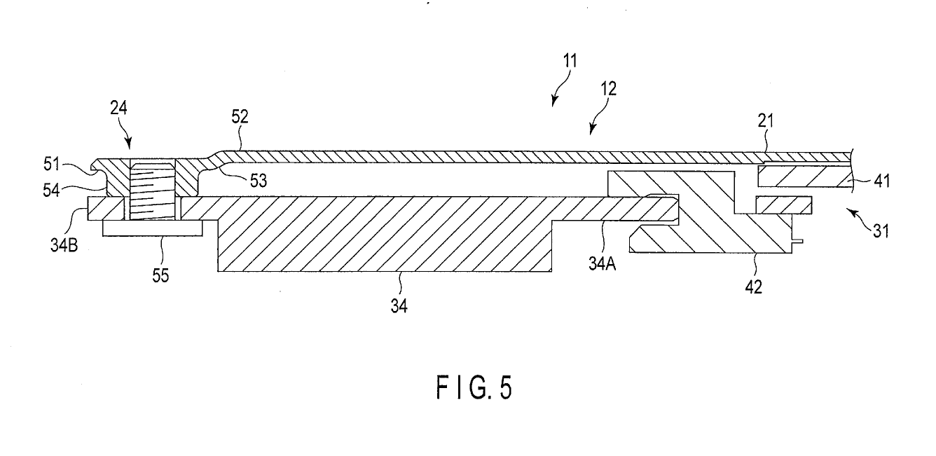

An electronic apparatus of a first embodiment will now be described with reference to FIGS. 1 to 5.
As shown in FIG. 1, in the following embodiment, a front side (that is, user side) is defined as front direction F, a depth side as viewed from the user is defined as a back direction B, a left side as viewed from the user is defined as left direction L, a right side as viewed from the user is defined as right direction R, an upper side as viewed from the user is defined as upper direction U, and a down side as viewed from the user is defined as down direction D.

As shown in FIG. 1, a portable computer, which is an example of an electronic apparatus, comprises a main body 12, a display 13 and a hinge 14 mediated between the main body 12 and the display 13 and having a shape of a slender rod as a whole. The hinge 14 supports the display 13 to be rotatable with respect to the main body 12. The hinge 14 can rotate the display 13 between a close state where a display panel 15 of the display 13 is laid on the main body 12 to face a keyboard 25, and an open state where the display 13 is set straight up with respect to the main body 12.

On both lateral ends of a rear surface of the display 13, a pair of rails 16 are provided such as to go along a vertical direction (an up-and-down direction) of a display screen 15A. The hinge 14 is slidable along the vertical direction of the display screen 15A on the rails 16. As the hinge 14 slides on the rails 16, the display 13 can be stacked on the main body 12 such that the rear surface of the display 13 faces the keyboard 25 (with the display panel 15 facing outwards).

The display 13 comprises the display panel 15 and a display cabinet 17 made of a synthetic resin and enclosing the display panel 15. In this embodiment, a liquid crystal display is used as an example of the display panel 15. The display panel 15 is not limited to a liquid crystal display panel, but may be some other type of display panel such as a plasma display panel, an organic EL, a plastic display panel or sheet display panel. The display cabinet 17 may be formed of a metal material as in the case of the main body cabinet 21.

As shown in FIGS. 1 to 4, the main body 12 comprises a main body cabinet formed of, for example, a metal material to have a box shape, a mount area 22 provided on an upper surface of the main body cabinet 21, a plurality of openings 23 formed in the mount area 22, a plurality of supports 24 projecting in the form of arms in the openings 23, a keyboard mounted on the mount area 22 from an outer side, and a touch pad 26 provided on the upper surface of the main body cabinet 21 on a further front side to the keyboard 25. A housing comprises the display cabinet 17 and the main body cabinet 21. The keyboard 25 is an example of the structure which covers the openings 23 and the supports 24 from an outer side.

The main body cabinet 21 (housing) is formed of, for example, a metal material such as a magnesium alloy, but the material of the main body cabinet 21 (housing) is not limited this. The material of the main body cabinet 21 may be, for example, a synthetic resin, or some other metal material such as an aluminum alloy.

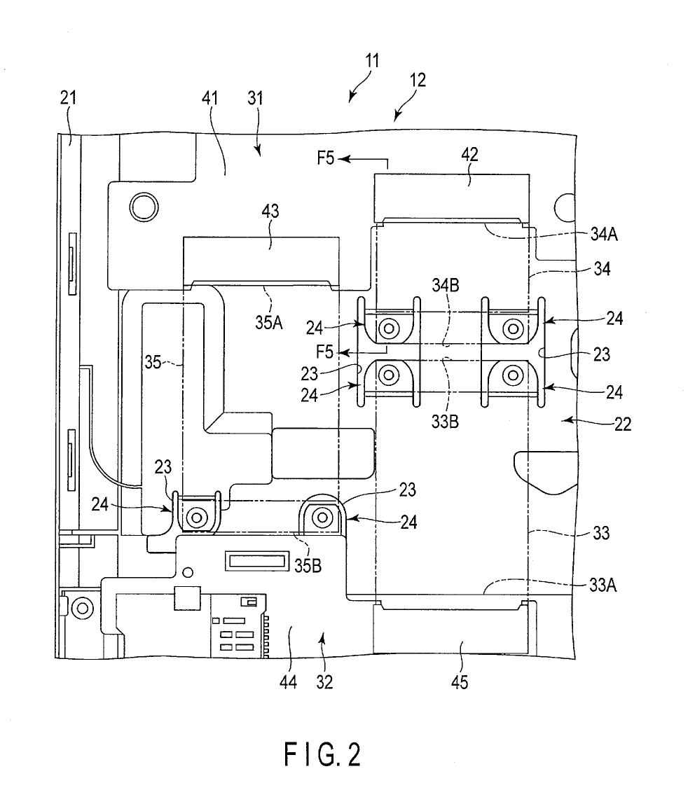

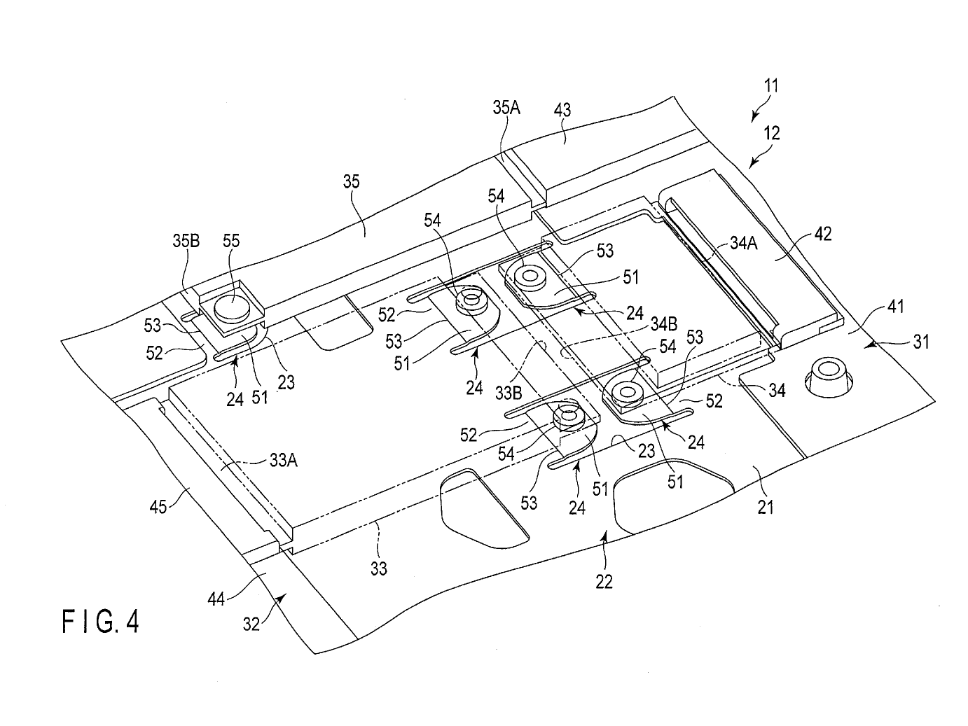

As shown in FIGS. 2 and 4, the main body 12 further comprises a first print circuit board 31 (main board), a second print circuit board 32 (sub-board), a full-size PCI Express card 33, a half-size PCI Express card 34, an SSD (solid state drive) card 35 inside the main body cabinet 21.

As shown in FIG. 2, the first print circuit board 31 comprises a first board 41, a plurality of circuit parts including CPU, mounted on the first board 41, a first connector 42 and a second connector 43 both mounted on the first board 41. The second print circuit board 32 comprises a second board 44 and a third connector 45 (the second connector) mounted on the second board 44.

The full-size PCI Express card 33 is, for example, a video card or a graphics card. Similarly, the half-size PCI Express card 34 as well is, for example, a video card or a graphics card. Each of the full-size PCI Express card 33, the half-size PCI Express card 34 and the SSD card 35 is an example of a unit or the second unit which is connected from the first connector 42 to the third connector 45 (connectors) by ends 33A, 34A and 35A on one side, and supported with the supports 24 by other ends 33B, 34B and 35B on the other side. The keyboard 25 is mounted on the mount area 22 and thus covers the openings 23 and the supports 24 from an outer side.

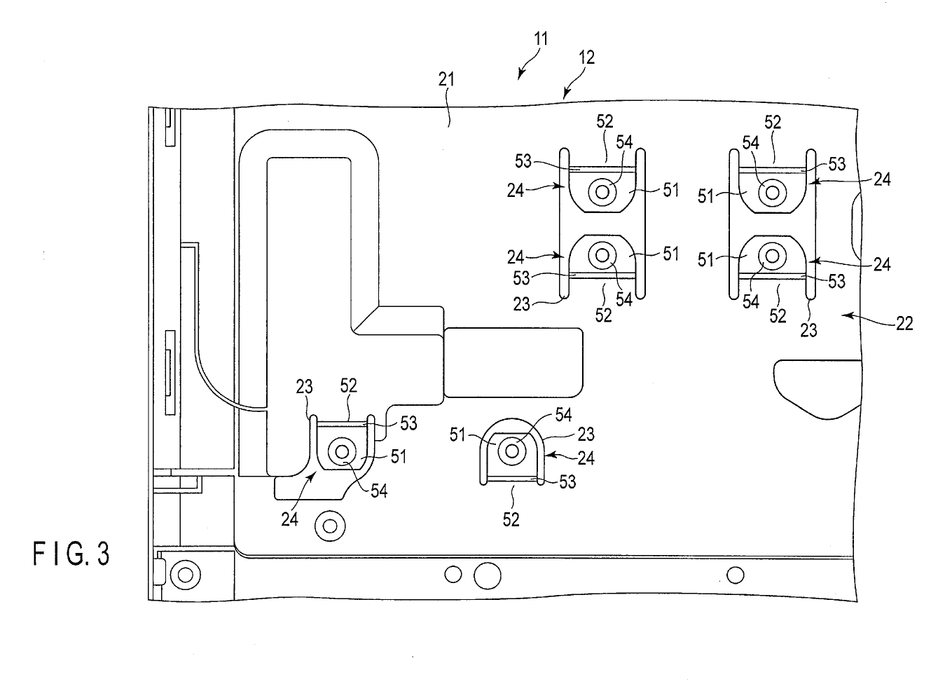

As shown in FIGS. 3 and 4, each of the supports 24 is formed on the main body cabinet 21 as an integral body. As mentioned above, each of the supports 24 supports a unit such as the full-size PCI Express card 33, the half-size PCI Express card 34 or the SSD card 35 in a cantilever manner by the ends 33B, 34B and 35B on the other side.

At sections of the mount area 22, where the full-size PCI Express card 33 and the half-size PCI Express card 34 are to be positioned, the supports 24 are provided in such a manner that, for example, two supports 24 (that is, a support and a second support) project in one opening 23. At these positions, distal ends of the supports 24 face each other. On the other hand, at a section of the mount area 22, where the SSD card 35 is to be positioned, the supports 24 are provided in such a manner that, for example, one support 24 projects in one opening 23.

Each of the ends 33B, 34B and 35B on the other side of the unit is elastically supported by a pair of supports 24. The supports 24 for the full-size PCI Express card 33 extend in a direction connecting the end 33A of one side of the unit to the other end 33B. The supports 24 for the half-size PCI Express card 34 extend in a direction connecting the end 34A of one side of the unit to the other end 34B. The supports 24 for the SSD card 35 extend in a direction connecting the end 35A of one side of the unit to the other end 35B.

At the sections where the full-size PCI Express card 33 and the half-size PCI Express card 34 are to be positioned, the supports 24 which support each respective unit are provided such as to extend in the same direction. On the other hand, at the section where the SSD card 35 is to be positioned, the supports 24 for this unit are provided such as to extend in, for example, opposite directions.

As shown in FIGS. 3 to 5, each of the supports 24 has a plate shape as in other sections of the main body cabinet 21, and the supports 24, as a whole, can exhibit flexibility in a thickness direction of the main body cabinet 21. Each of the supports 24 comprises a distal end 51 (distal end and second distal end) situated on further inner sides than the other sections of the main body cabinet 21, a proximal end 52 formed integrally and continuously from an edge which defines a respective opening 23, a step 53 formed at a section between the distal end 51 and the proximal end 52, and a boss 54 formed in the distal end 51.

In this embodiment, the distal end 51 is processed to remove its sharp corner portion and has a round shape. The boss 54 is formed in a central part of the distal end 51. As a screw 55 is mounted on the boss 54, the distal end 51 of the respective support 24 can support the ends 33B, 34B and 35B on the other side of the unit. The step 53 is provided in a middle of each support 24, and is continuous to the distal end 51 and the proximal end 52. Further, the openings 23 and the supports 24 are formed in a collective manner by, for example, the press working.

In this embodiment, each support 24 extends along the direction connecting the ends 33A, 34A and 35A on one side of the unit to the ends 33B, 34B and 35B on the other side. With this structure, even in the case where the unit is shaken up and down with respect to the connector as a center, the supports 24 can support the unit to follow the shaking of the unit. In this manner, the unit is not subjected to stresses including twisting, chances are lowered that the unit is, for example, damaged.

According to the first embodiment, the electronic apparatus comprises a housing provided with at least one opening 23, a connector contained inside the housing, a unit contained inside the housing and connected to the connector by the ends 33A, 34A and 35A on one side of the unit, and flexible supports each formed on the housing as one unit and projecting in a respective opening 23 and supporting ends 33B, 34B and 35B on the other side of the unit.

With this structure, the supports 24 are formed integrated with the housing and therefore the number of parts can be decreased, thereby making it possible to reduce the cost and simplify the structure itself. Further, the unit is elastically supported by the ends 33B, 34B and 35B on the other side of the unit, thereby making is possible to prevent the unit from being exposed to excessive stress.

The electronic apparatus comprises, on each of the supports 24, a distal end 51 situated on an inner side of the housing and configured to support the ends 33B, 34B and 35B on the other side of the unit, and a step 53 formed in a middle of the support 24 such as to be continuous to the distal end 51.

With this structure, the distal end 51 can be situated on an inner side of the housing due to the presence of the step 53, thereby making it possible to reserve a space for the stroke in which the support 24 may warp in its thickness direction (in particular, a space for the stroke in which the support 24 may warp towards an outer side of the housing). In this manner, the warping of the support 24 is not interfered with, but allowed smoothly, thereby making it possible to reduce the stress applied to the unit.

The supports 24 extend in the direction connecting the ends 33A, 34A and 35A of one side to the end 33B, 34B and 35B of the other side. With this structure, if the even in the case where the unit is shaken up and down with respect to the connector and the ends 33A, 34A and 35A of one side, which serve as the center of the shaking (fulcrum) as vibration, shock or the like is applied, the supports 24 can smoothly move to follow the unit. In this manner, the stresses in the stretching direction and compressing direction applied to the unit, and the stress in the twisting direction can be suppressed, and the unit can be elastically supported by the respective supports 24.

The electronic apparatus comprises a second connector contained inside the housing, a second unit connected to the second connector by the ends 33A, 34A and 35A on one side, and a second support projecting in a respective opening 23 and supporting the second unit by the ends 33B, 34B and 35B on the other side of the second unit. With this structure, the first support and the second support are provided in one opening 23, and therefore the number of openings 23 can be reduced, thereby making it possible to simplify the structure.

The second support comprises a second distal end situated in a vicinity of the distal end 51 of the support 24. With this structure, some other unit can be arranged in a close vicinity of the unit, and thus the efficiency of the usage of the space inside the housing can be improved, thereby making it possible to achievable a high degree of integration.

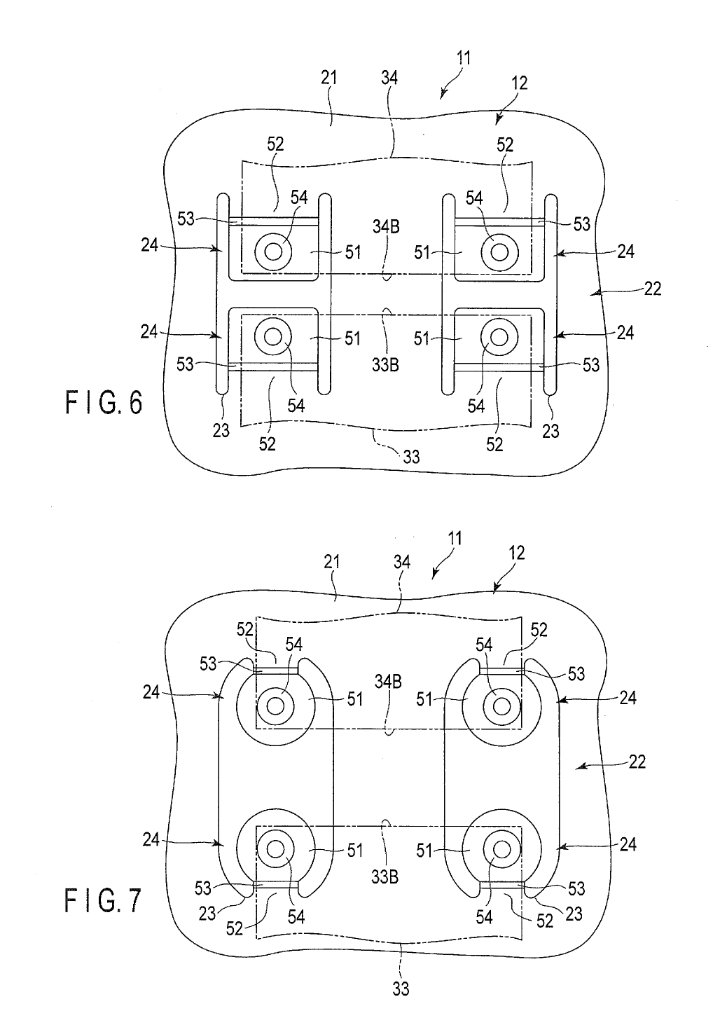

Subsequently, the second embodiment of the electronic apparatus will now be described with reference to FIG. 6. A portable computer 11, which is an example of the electronic apparatus of the second embodiment, is different from that of the first embodiment in the respect that the shape of the supports 24 is changed, but the other parts are common to those of the first embodiment. Therefore, the different part with respect to the first embodiment will be mainly explained, and explanations on the common parts will be omitted.

In the second embodiment, each of supports 24 has a distal end 51 having substantially a rectangular shape. Each of the supports 24 supports a full-size PCI Express card 33 by the end 33B on the other side, and supports a half-size PCI Express card 34 by the end 34B on the other side, both in a cantilever manner. The full-size PCI Express card 33 and the half-size PCI Express card 34 each are an example of a unit or second unit, which is connected to the respective connector by the ends 33A and 34A on one side, and supported by the supports 24 by the ends 33B and 34B on the other side.

Further, FIG. 7 shows a modified version of the second embodiment. In this modified version, the distal end 51 has a round shape. The supports 24 support the full-size PCI Express card 33 by the end 33B on the other side and the half-size PCI Express card 34 by the end 34B on the other side, both in a cantilever manner. Further, the proximal end 52 is formed to have, for example, a width smaller than that of the distal end 51, which makes it even easier for the supports 24, as a whole, exhibit a further flexibility.

According to the second embodiment, the distal end 51 of each support 24 can have any shape. According to the modified version of the second embodiment, the proximal end 52 is formed to have a width smaller than that of the distal end 51, and therefore the flexibility of the supports as a whole can be improved, thereby making it possible to support the unit further elastically.

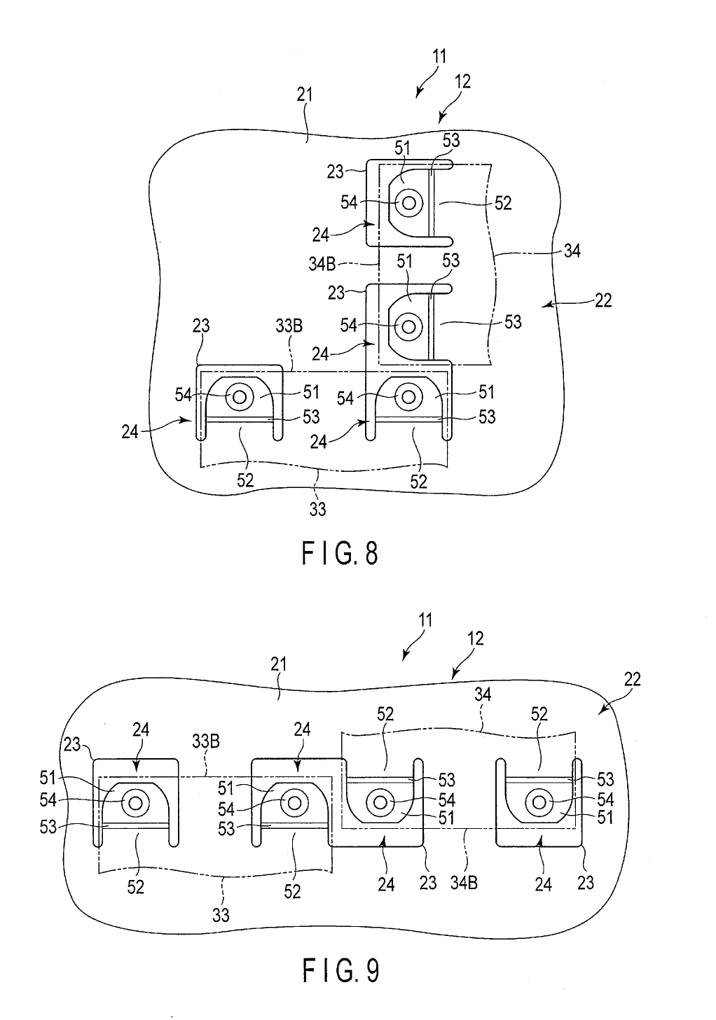

Subsequently, the third embodiment of the electronic apparatus will now be described with reference to FIG. 8. A portable computer 11, which is an example of the electronic apparatus of the third embodiment, is different from that of the first embodiment in the respect that the layout of the supports 24 is changed, but the other parts are common to those of the first embodiment. Therefore, the different part with respect to the first embodiment will be mainly explained, and explanations on the common parts will be omitted.

In the third embodiment, two supports 24 are arranged to project in one of the openings 23. Further, one support 24 projects in each of two openings 23 other than the opening 23. Each of the supports 24 is formed to be integrated with the main body cabinet 21. Each support supports a full-size PCI Express card 33 by the end 33B on the other side, and supports a half-size PCI Express card 34 by the end 34B on the other side, both in a cantilever manner.

At sections where the two supports 24 are provided in the one opening 23, the direction in which one of the supports 24 extends, is a direction which crosses (normally) a direction in which the other support 24 extends. But this embodiment is similar to the first embodiment in the respect that each support 24 extends along the direction connecting the ends 33A, 34A and 35A on one side of the unit to the ends 33B, 34B and 35B on the other side. Further, the shape of the supports 24 is similar to that of the first embodiment.

According to the third embodiment, one of the supports 24 projecting in the opening 23 extends in a direction which crosses the other support 24 projecting in the same opening 23. With this structure as well, some other unit can be arranged in a close vicinity of the unit, and thus the efficiency of the usage of the space inside the housing can be improved, thereby making it possible to achieve a high degree of integration. Further, with this structure, even in the case where the unit is shaken with respect to the connector and the ends 33A, 34A and 35A of one side, which serve as the center of the shaking (fulcrum) as vibration, shock or the like is applied, the supports 24 can smoothly move to follow the unit. In this manner, the stresses thus applied to the unit can be suppressed.

Subsequently, the fourth embodiment of the electronic apparatus will now be described with reference to FIG. 9. A portable computer 11, which is an example of the electronic apparatus of the third embodiment, is different from that of the first embodiment in the respect that the layout of the supports 24 is changed, but the other parts are common to those of the first embodiment. Therefore, the different part with respect to the first embodiment will be mainly explained, and explanations on the common parts will be omitted.

In the fourth embodiment, two supports 24 are arranged to project in one of the openings 23.
Further, one support 24 projects in each of two openings 23 other than the opening 23. Each of the supports 24 is formed to be integrated with the main body cabinet 21. Each support supports a full-size PCI Express card 33 by the end 33B on the other side, and supports a half-size PCI Express card 34 by the end 34B on the other side, both in a cantilever manner.

At sections where the two supports 24 are provided in the one opening 23, the direction in which one of the supports 24 extends, is a direction which opposite to a direction in which the other support 24 extends. But unlike the first embodiment, one of the supports provided in the opening 23 is provided to be displaced (off from the same line, or the opposing position) with respect to the other support 24 in the opening 23. It should be noted that this embodiment is similar to the first embodiment in the respect that each support 24 extends along the direction connecting the ends 33A, 34A and 35A on one side of the unit to the ends 33B, 34B and 35B on the other side. Further, the shape of the supports 24 is similar to that of the first embodiment.

According to the fourth embodiment, one of the supports 24 projecting in the opening 23 is provided to be displaced (off from the same line, or the opposing position) with respect to the other support 24 projecting in the opening 23. With this structure as well, some other unit can be arranged in a close vicinity of the unit, and thus the efficiency of the usage of the space inside the housing can be improved, thereby making it possible to achieve a high degree of integration. Further, with this structure, even in the case where the unit is shaken (rotated) with respect to the connector and the ends 33A, 34A and 35A of one side, which serve as the center of the shaking (fulcrum) as vibration, shock or the like is applied, the supports 24 can smoothly move to follow the unit. In this manner, the stresses thus applied to the unit can be suppressed.

The electronic apparatus is not limited to the portable computer 11 discussed in each of the above-provided embodiments, but the present embodiment are applicable also to some other type of electronic apparatus such as mobile telephone device and electronic book readers. Further, as examples of the unit and the second unit supported by the supports 24 by the ends 33B, 34B and 35B on the other side discussed above, the full-size PCI Express card 33, the half-size PCI Express card 34 and the SSD card 35 are listed, but the examples of the unit and the second unit are not limited to these. Examples of the units include hard disk drive units, wireless LAN modules, various types of flash memory cards, optical disk drive units (ODD). Furthermore, in the above-provided embodiments, the keyboard 25 is indicated as an example of the part which covers the openings 23 and the supports 24, but the part is not limited to this. As this structural part, a decorative laminate designed to cover the openings 23 and the supports 24, a lid-shaped member or the like can be used as needed.

Moreover, the electronic apparatus is not limited directly to the above-described embodiment, but it can be realized while remodifying the structural elements thereof within the scope where the essense thereof remains. Further, various types of embodiments can be achieved by combining or rearranging various structural elements disclosed in the embodiment appropriately. For example, some of the structural elements may be deleted from the entire structure disclosed in the embodiment. Further, structural elements of various versions may be combined together as needed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a housing with at least one opening;
a connector in the housing;
a unit in the housing and connected to the connector by one end; and
a flexible support integrated with the housing, and projecting in the opening, configured to support an other end of the unit.

2. The electronic apparatus of claim 1, comprising:
a distal end on the support and located in the housing, configured to support the other end of the unit; and
a step in a middle of the support and continuous to the distal end.

3. The electronic apparatus of claim 2, wherein the support extends along a direction connecting the one end to the other end.

4. The electronic apparatus of claim 3, comprising:
a second connector in the housing;
a second unit connected to the second connector by one end;
a flexible second support projecting in the opening, configured to support an other end of the second unit.

5. The electronic apparatus of claim 4, wherein the second support comprises a second distal end in a vicinity of the distal end of the support.

6. An electronic apparatus comprising:
a housing with at least one opening;
a connector in the housing;
a unit in the housing and connected to the connector by one end; and
a plurality of flexible supports integrated with the housing and projecting in the opening, configured to support an other end of the unit.
